(19) United States
(12) Patent Application Publication
(10) Pub. No.: US 2010/0303515 A1
(43) Pub. Date: Dec. 2, 2010

(54) IMAGE TRANSFER DEVICE, IMAGE FORMING APPARATUS, AND IMAGE TRANSFERRING METHOD

(75) Inventor: Masaharu KITAGAWA, Shizuoka-ken (JP)

Correspondence Address: PATTERSON & SHERIDAN, L.L.P., 3040 POST OAK BOULEVARD, SUITE 1500, HOUSTON, TX, 77056, US

(73) Assignees: Kabushiki Kaisha Toshiba, Tokyo (JP); Toshiba Tec Kabushiki Kaisha, Tokyo (JP)

(21) Appl. No.: 12/784,452

(22) Filed: May 20, 2010

Related U.S. Application Data
(60) Provisional application No. 61/181,965, filed on May 28, 2009.

(30) Foreign Application Priority Data
Feb. 18, 2010 (JP) 2010-033677

(51) Int. Cl. G03G 15/01; G03G 15/16

(52) U.S. Cl. 399/302; 399/313

(57) ABSTRACT

According to one embodiment, an image transfer device includes an endless transfer belt which is belted movably around a pair of separate supporting members to form a belt loop, a transfer member facing an image carrier via the transfer belt, to transfer a developed image formed on the image carrier onto the transfer belt, and a belt pressing member configured to act the transfer belt to increase an area of the transfer belt contacting the image carrier.

### CROSS-REFERENCE TO RELATED APPLICATION

This application is based upon and claims the benefit of priority from the prior U.S. Patent Application No. 61/181,965, filed on May 28, 2009, the entire contents of which are incorporated herein by reference.

This application is also based upon and claims the benefit of priority from Japanese Patent Application No. 2010-33677, filed on Feb. 18, 2010, the entire contents of which are incorporated herein by reference.

### TECHNICAL FIELD

Exemplary embodiments described herein relate to an image transfer device, an image forming apparatus provided with the image transfer device, and an image transferring method.

### BACKGROUND

In an image forming apparatus using a tandem color system, image forming units of each color (Y: yellow, M: magenta, C: cyan and K: black) with drum shaped photo conductors are arranged in parallel. The toner images of each color formed respectively on the photo conductors of each color are primarily transferred on an endless intermediate transfer belt, and then the transferred color image is secondary transferred on a recording medium such as a sheet and so on to obtain a color image output. The photo conductors of each color and the intermediate transfer belt are usually arranged so that a tangent line of them forms a straight line, and the extents of the areas in which the intermediate transfer belt contact the photo conductors of each color are fixed.

In the image forming apparatus as described above, a recording medium is conveyed to a secondary transfer position, and a color image on the intermediate belt is transferred on the recording medium. By the shock caused when the recording medium rushes into or escapes from the secondary transfer position, first transfer positions may shift where the toner images are transferred on the intermediate transfer belt. When the primary transfer positions shift as this, an image failure may be caused.

As an example to show a method to hold the primary transfer position tightly, JP-A 2007-199636 is quoted. In JP-A 2007-199636, out of the four toner forming portions to form a color image, a photo conductor drum forming a black toner image positioned nearest to a secondary transfer position where the toner images are transferred on the recording medium is bitten into the inside of the belt loop of the intermediate transfer belt. That the contact property between the photo conductors and the intermediate transfer belt can be raised by this is shown.

But, in the mechanism of JP-A 2007-199636, the photo conductor forming a black image becomes in the state to contact the intermediate transfer belt at all times. If the photo conductor contacts the intermediate transfer belt at all times, as the photo conductor deteriorates, that the photo conductor contacts the intermediate transfer belt at all times is not preferable. In addition, in the mechanism of JP-A 2007-199636, only to raise the contact property between the photo conductor and the intermediate transfer belt can be performed.

### SUMMARY

An aspect of the present disclosure relates to an image transfer device, containing: an endless transfer belt which is belted around a pair of separate supporting members to form a belt loop and is provided so as to move freely; a transfer member, provided to face an image carrier via the transfer belt, to transfer a developed image formed on the image carrier on the transfer belt; and a belt pressing member, arranged to face the image carrier via the transfer belt, to act the transfer belt so as to increase an area contacting the image carrier.

Another aspect of the present disclosure relates to an image forming apparatus, containing: a supply potion to supply a recording medium; an image forming portion to form a document image as a developed image on an image carrier; and a transfer device to transfer the developed image formed on the image carrier on an endless transfer belt; the transfer device including: a pair of supporting members arranged separately around which the endless transfer belt is belted so as to move freely to form a belt loop; a transfer member, provided to face the image carrier via the transfer belt, to transfer a developed image formed on the image carrier on the transfer belt; a secondary transfer member provided at a secondary transfer position where the developed image transferred on the transfer belt is transferred on the recording medium supplied from the supply portion; and a belt pressing member arranged to face the image carrier via the transfer belt, to act the transfer belt so as to increase an area of the transfer belt contacting the image carrier.

Further, an aspect of the present disclosure relates to an image transferring method, containing: contacting an endless transfer belt which is belted around a pair of separate supporting members to form a belt loop and is provided so as to move freely, with an image carrier for a color use and an image carrier for a monochrome use; transferring a developed image formed on the image carrier for the color use and the image carrier for the monochrome use on the transfer belt; separating the transfer belt from the image carrier for the color use, and switching the transfer belt so as to contact only the image carrier for the monochrome use; acting the pressing member to the transfer belt when switching so as to increase an area of the transfer belt contacting the image carrier for the monochrome use; and increasing the contact area of the transfer belt, and transferring the developed image formed on the image carrier for the monochrome use on the transfer belt.

### BRIEF DESCRIPTION OF THE DRAWINGS

FIG. 1 is a schematic construction diagram of an image forming apparatus;

FIG. 2 is a schematic construction diagram of a transfer device in a first embodiment;

FIG. 3 is a schematic construction diagram of a transfer device in a second embodiment in the state of the color print mode;

FIG. 4 is a schematic construction diagram of the transfer device in the second embodiment in the state of the monochrome print mode;

FIG. 5 is a schematic construction diagram of the transfer device in the second embodiment in the state of the all separation mode;

FIG. 6 is a schematic construction diagram of a transfer device in a third embodiment in the state of the color print mode; and

FIG. 7 is a schematic construction diagram of the transfer device in the third embodiment in the state of the monochrome print mode.

### DETAILED DESCRIPTION

Hereinafter, embodiments will be described with reference to the drawings.

### First Embodiment

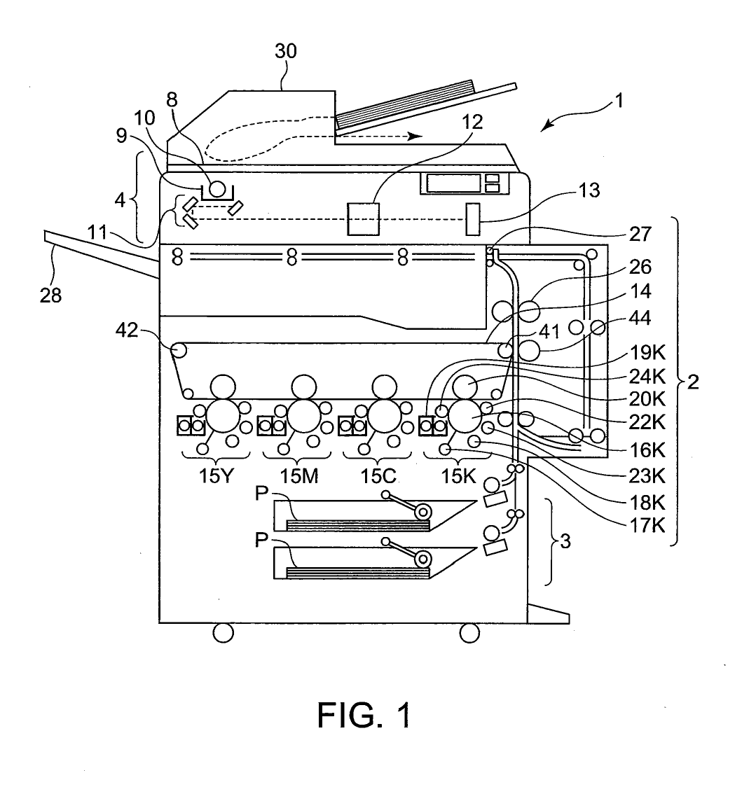

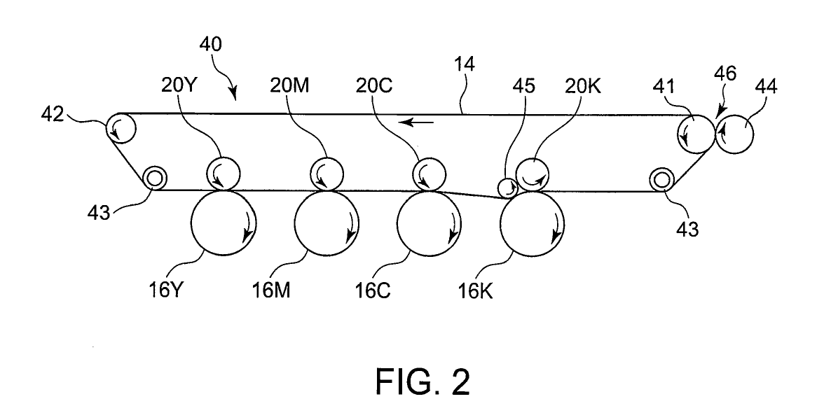

A first embodiment will be described with reference to FIG. 1 through FIG. 2.

FIG. 1 is a sectional view showing an internal construction of an image forming apparatus. An image forming apparatus 1 includes an image reader 4 to take in a document as an image data, and an image forming portion 2 to output the image data as a visible image. The image forming portion 2 includes image forming units each including an image carrier such as a drum shaped photo conductor and so on, and a fixing device and so on. The image forming apparatus 1 further includes a sheet supply portion 3 to supply a sheet P of an optional size which will be used as a image recording medium to the image forming portion 2.

The image reader 4 includes a permeable document table 8, a carriage 9 carrying an exposure lamp 10, a mirror 11, an imaging lens 12 to converge the reflected light, and a CCD (Charge Coupled Device) 13 to convert the image information by the reflected light into an analog signal.

As each of yellow (Y), magenta (M), cyan (C) and black (K) image forming units is constructed in the same way and acts in the same manner, a black (K) image forming unit 15K is taken for example and will be described.

The image forming unit 15K includes a drum shaped photo conductor 16K as the image carrier, a laser unit 17K to form an electrostatic latent image on the photo conductor 16K, and a charging device 18K, a developing device 19K, a cleaner 22K and a neutralization lamp 23K which are arranged sequentially around the photo conductor 16K.

A document to be copied is loaded on a document table 8, or is set on a known automatic document feeder 30 arranged on the document table 8. When a copy button is pushed down, the exposure lamp 10 irradiates a light onto the document on the document table 8 or the document sent to the exposure position of the document table 8 by the automatic document feeder 30. The reflected light from the document is guided by the mirror 11, converged by the imaging lens 12, and the image of the reflected light is projected on the CCD 13. The light from the exposure lamp 10 scans the document surface in synchronism with the movement of the carriage 9 (in a direction from left to right, in FIG. 1). The scanning light is taken in the CCD 13 as an image information, is outputted as an analog signal, and then is converted to a digital signal. The digitized image information is transmitted to the laser unit 17K as an image data, after an image processing is executed where necessary. The image information converted to the digital signal may be stored temporarily in a memory device such as a HDD (Hard Disk Drive) and so on.

In the image forming portion 2, when an image forming action starts, the charging unit 18K supplies charge to an outer surface of the rotating photo conductor 16K, to charge the outer surface of the photo conductor 16K in a uniform potential. The laser unit 17K irradiates the laser beam which is modulated with the image date transmitted from the CCD 13 toward the outer surface of the photo conductor 16K. The laser beam scans along the axis of rotation of the drum shaped photo conductor 16K, and forms electrostatic latent image corresponding to the image data on the outer surface of the rotating photo conductor 16K. The developing device 16K supplies a developing agent such as toner and so on to the outer surface of the photoconductor 16K to convert the electrostatic latent image into a developed image.

The developing device 19K includes a developing roller 24K which is provided rotatably. The developing roller 24K faces the photo conductor 16K, and supplies the toner onto the photo conductor 16K by the rotation of the developing roller 24K. When the toner image is formed on the outer circumference face of the photo conductor 16K, a primary transfer roller 20K electrostatically transfers the toner image onto a transfer belt 14. The primary transfer roller 20K is a transfer member and contacts the photoconductor 16K via the intermediate belt 14. A mechanism portion to perform transferring in this manner is particularly referred to as a transfer device. Description regarding the transfer device will be stated later. The toner on the photo conductor 16K is removed by the cleaner 22K positioned at the downstream in the rotation direction of the photo conductor 16K than the primary transfer roller 20K. The neutralization lamp 23K removes the remaining charge on the outer surface of the photo conductor 16K. In case of forming a color image, the above-described action is similarly performed in each of the image forming units 15Y, 15M and 15C.

The secondary transfer roller 44 electrostatically transfers the toner image transferred on the intermediate transfer belt 14 onto the sheet P which is conveyed from the sheet supply portion 3 through the conveying path. The sheet P on which the toner image is transferred is conveyed to a fixing device 26. The fixing device 26 fixes the toner image on the sheet P. A conveying roller 27 discharges the sheet P on which the toner image is fixed, on a sheet receiving tray 28 which is a discharge portion. The above-description is an outline of an action to form an image on the sheet P which is the recording medium.

A transfer device 40 will be described. FIG. 2 is a schematic construction diagram of the transfer device 40 according to the first embodiment. The transfer device 40 includes a driving roller 41 and a driven roller 42 which are supporting members, a plurality of tension rollers 43 and the endless intermediate transfer belt 14 which is belted around the driving roller 41, the driven roller 42 and the tension rollers 43 to form a belt loop. A plurality of the tension rollers 43 give a tensile force to the intermediate transfer belt 14. The transfer device 40 further includes first transfer rollers 20Y, 20M, 20C and 20K which face photo conductors 16Y, 16M, 16C and 16K, respectively via the intermediate transfer belt 14. The primary transfer rollers 20Y, 20M, 20C and 20K respectively form primary transfer positions to transfer the images on the photo conductors 16Y, 16M, 16C and 16K on the intermediate transfer belt 14. That is, the toner images formed on the photo conductors 16Y, 16M, 16C and 16K are adhered onto the intermediate transfer belt 14.

The transfer device 40 further includes a secondary transfer roller 44 contacting with the driving roller 41 via the intermediate transfer belt 14 which is a secondary transfer member to form a secondary transfer position 46. The intermediate transfer belt 14 is moved in the direction of an arrow by the rotation force of the driving roller 41 which is rotation driven in a counter clockwise direction by a driving mechanism. As shown in the drawing, the secondary transfer roller 44 is located at a downstream side of the primary transfer roller 20K in the moving direction of the intermediate transfer belt 14.

In the transfer device 40, an idle roller 45 which is a belt pressing member is arranged between the black (K) primary transfer roller 20K and the cyan (C) primary transfer roller 20C to contact with the intermediate transfer belt 14. The idle roller 45 is arranged so that the belt loop of the intermediated transfer belt 14 expands outside in the state that the idle roller 45 contacts with the black (K) photo conductor 16K via the intermediate transfer belt 14. The idle roller 45 is driven and rotates by the rotation movement of the intermediate transfer belt 14. By providing the idle roller 45 as described above, a winding amount of the intermediate transfer belt 14 around the photo conductor 16K increases. In other words, because the idle roller 45 acts the intermediate transfer belt 14, a contact area of the intermediate transfer belt 14 with the photo conductor 16K can be increased.

As described above, the idle roller 45 is located between the black (K) photo conductor 16K and the cyan (C) photo conductor 16C so that the belt loop of the intermediated transfer belt 14 expands outside, that is, in the direction of the photo conductor 16K. Therefore, the winding amount of the intermediate transfer belt 14 around the photo conductor 16K increases. As a result, the contact property of the intermediate transfer belt 14 with the photo conductor 16K increases. For the reason, the shock to the intermediate transfer belt 14 and, in addition, the effect to the primary transfer positions can be reduced which are caused in case that the sheet P rushes into or escapes from the secondary transfer position 46.

In the above-described embodiment, the idle roller 45 is provided between the black (K) photo conductor 16K and the cyan (C) photo conductor 16C, but the idle roller 45 may be provided between the black (K) photo conductor 16K and the secondary transfer position 46. In this case, the same effect can be obtained as in the above-described embodiment.

In the above-described embodiment, the idle roller 45 is provided only at the black (K) photo conductor 16K which is closest to the secondary transfer position 46 and is easy to receive most the effect of the shock caused at the secondary transfer position 46 so that the winding amount of the intermediate transfer belt 14 increases. But, without limited to the black (K) photo conductor 16K, the idle rollers 45 may be provided at the yellow (Y), magenta (M) and cyan (C) photo conductors 16Y, 16M and 16C to increase the winding amounts of the intermediate transfer belt 14 in the same way as in the black (K) photo conductor 16K.

According to the above-described embodiment, to hold the primary transfer position tightly and to prevent the image failure due to the shock caused in case that the sheet P rushes into or escapes from the secondary transfer position 46 can be made possible, by providing the idle roller 45 so as to increase the winding amount of the intermediate transfer belt 14 around the photo conductor.

### Second Embodiment

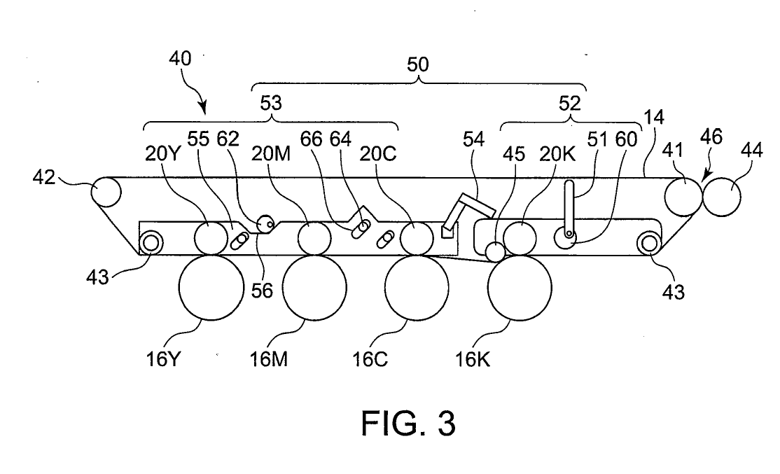

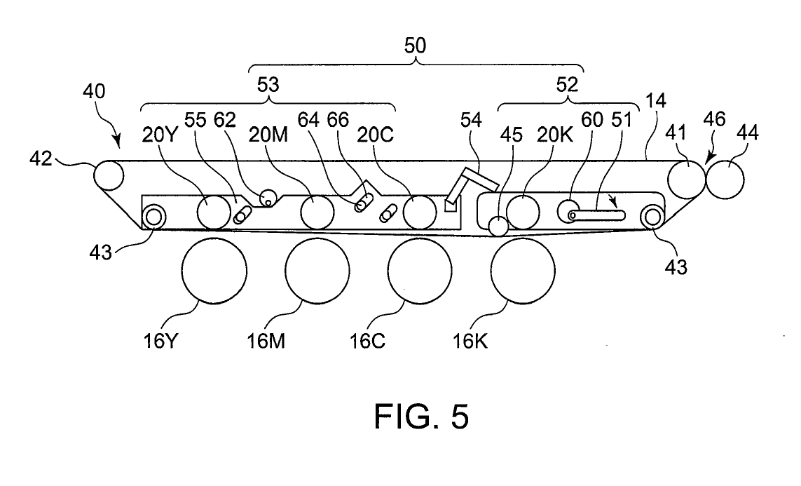

A second embodiment will be described with reference to FIG. 3 thorough FIG. 5. Hereinafter, the same reference numerals are used for the same parts in the first embodiment, and only the characteristic parts of the present embodiment will be described.

The image forming apparatus 1 according to the present embodiment is provided with a switching mechanism to switch among a color print mode to form a color image and a monochrome print mode to form a monochrome image on the sheet P which is the recording medium, and in addition an all separation mode to separate the intermediate transfer belt 14 from all the photo conductors 16Y, 16M, 16C and 16K at the time of transportation and so on.

In the color print mode, primary transfer rollers 20K, 20Y, 20M, and 20C transfer the developed images of each color from the photoconductors 16K, 16Y, 16M and 16B onto the intermediate transfer belt 14 by contacting the intermediate transfer belt 14 to the photo conductors 16K, 16Y, 16M and 16B of each color.

In the monochrome print mode, the black (K) developed image may be transferred to the intermediate transfer belt 14 from the black (K) photo conductor 16K by contacting the intermediate transfer belt 14 to only the black (K) photo conductor 16K. For the reason, the photo conductors 16Y, 16M and 16C of the other colors which are not required to act are separated from the intermediate transfer belt 14, to reduce the friction between the yellow (Y), magenta (M), and cyan (C) photo conductors 16Y, 16M and 16C and the intermediate transfer belt 14.

FIG. 3 is a schematic construction diagram of the transfer device 40 in the state of the color print mode. The transfer device 40 in the present embodiment includes a switching unit 50 to switch among the color print mode, the monochrome print mode and the all separation mode. The switching unit 50 (switching portion) includes a monochrome unit 52 and a color unit 53. The monochrome unit 52 includes the black (K) primary transfer roller 20K, the idle roller 45 and a manual operating lever 51 fitted to an eccentric cam 60. The color unit 53 includes the yellow (Y), magenta (M) and cyan (C) primary transfer rollers 20Y, 20M, and 20C, an eccentric cam 62 and a guide pin 64. The eccentric cam 62 is inserted in a recess 56 at the upper portion of a frame 55 of the color unit 53. A motor is connected to the eccentric cam 62 of the color unit 53, and the eccentric cam 62 rotates by the motor. The guide pin 64 is fixed, and is inserted in a long hole 66 formed on the frame 55. A switching member 54 connects between the monochrome unit 52 and the color unit 53.

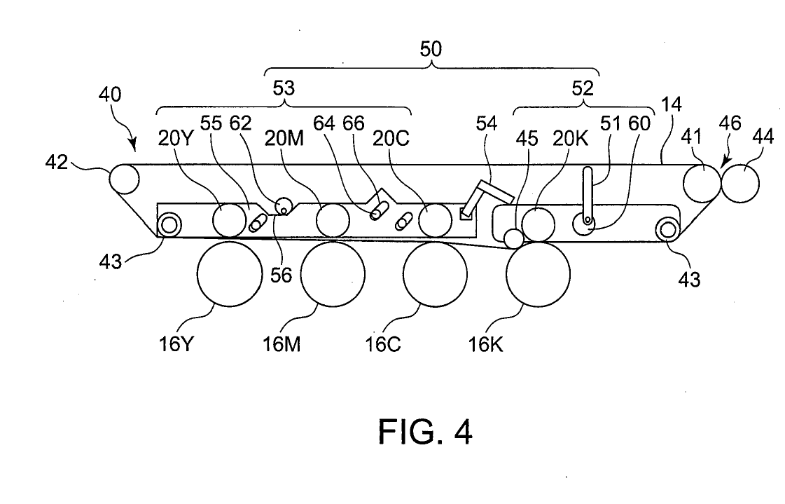

FIG. 4 is a schematic construction diagram showing the transfer device 40 in the state of the monochrome print mode. In the monochrome mode, the eccentric cam 62 of the color unit 53 rotates by the motor. When the eccentric cam 62 moves while rotating on the recess 56 of the frame 55, whole the color unit 53 moves upward along the long hole 66 in which the guide pin 64 is inserted. Therefore, the yellow (Y), magenta (M), and cyan (C) photo conductors 16Y, 16M and 16C separate respectively from the intermediate transfer belt 14.

FIG. 5 is a schematic construction diagram showing the transfer device 40 in the state of the all separation mode. In order to move into the all separation mode, the eccentric cam 60 of the monochrome unit 52 is rotated by rotating further the operating lever 51 in the clockwise direction on the figure by 90 degrees in the state of the monochrome print mode. By the rotation of the eccentric cam 60, the monochrome unit 52 moves upward. As the monochrome unit 52 moves upward as this, the black (K) photo conductor 16K separates from the idle roller 45 and the intermediate transfer belt 14.

If the present embodiment is used, when to contact the photo conductors with the intermediate transfer belt is not required such as in the time of transportation, to hold the primary transfer positions tightly only when printing can be made possible by moving the idle roller 45 along with the photo conductors. For the reason, compared with the case where the photo conductors and the intermediate transfer belt are always contacted, the deterioration of the intermediate transfer belt 14 due to the friction to the photo conductors can be prevented.

In the present embodiment, the idle roller 45 locates only at the black (K) image forming unit in the same way as in the first embodiment. But the idle rollers may locate at the yellow (Y), magenta (M) and cyan (C) image forming units, too. In this case, a construction may be used in which the idle roller moves along with the movement of the color unit 53, and can be separated from the photo conductors along with the intermediate transfer belt.

In the present embodiment, switching to the all separation mode is performed using the manual operating lever 51, but a switching mechanism to each mode is not limited to this switching mechanism.

### Third Embodiment

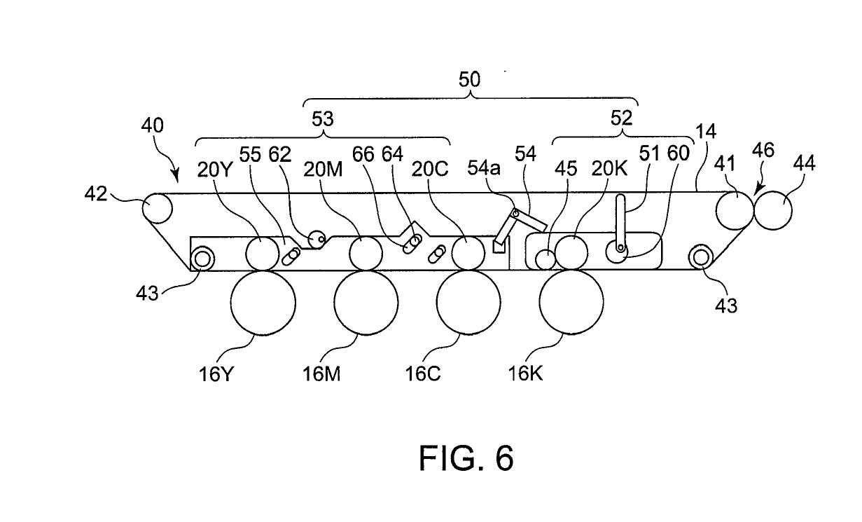

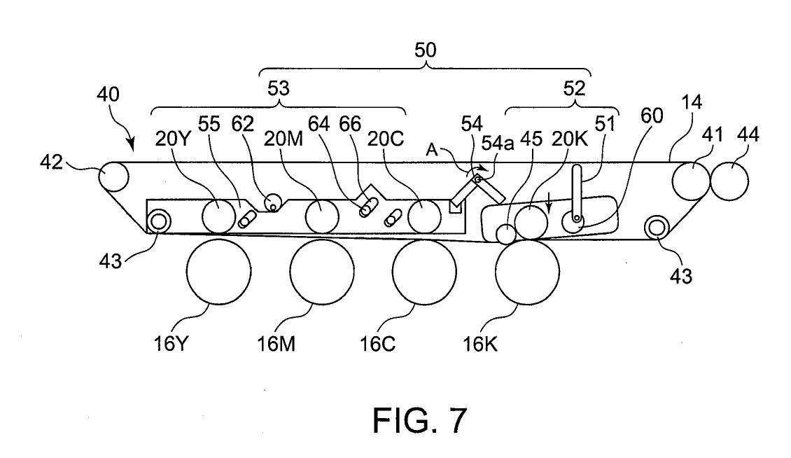

A third embodiment will be described with reference to FIG. 6 through FIG. 7. Hereinafter, the same reference numerals are used for the same parts in the first and second embodiments, and only the characteristic parts of the present embodiment will be described.

A transfer device according to the present embodiment includes a switching mechanism to switch between the color print mode and the monochrome print mode in the same way as in the second embodiment.

FIG. 6 is a schematic construction diagram of the transfer device 40 according to the present embodiment in the state of the color print mode. The members provided in the transfer device 40 and the method to move the color unit are the same as in the second embodiment. In the present embodiment, when the color print mode is used, the idle roller 45 is not located to increase the winding amount of the intermediate transfer belt 14 around the black (K) photo conductor 16K. The switching member 54 includes a fulcrum point 54a and rotates centering around the fulcrum point 54a.

FIG. 7 is a schematic diagram of the transfer device 40 according to the present embodiment in the state of the monochrome print mode. When the color unit 53 moves upward so that the yellow (Y), magenta (M) and cyan (C) photo conductors separate from the intermediate transfer belt 14, the switching member 54 rotates in a direction A as shown in FIG. 7. By the rotation of the switching member 54 in the direction A, the monochrome unit 52 is pushed down by the switching member 54. As the portion of the eccentric cam 60 of the monochrome unit 52 is fixed, the monochrome unit 52 inclines. And, the idle roller 45 moves to expand the belt loop of the intermediate transfer belt 14, so that the winding amount of the intermediate transfer belt 14 around the black (K) photo conductor 16K increases.

According to the present embodiment, the idle roller 45 can be located to increase the winding amount of the intermediate transfer belt 14 around the black (K) photo conductor 16K only in the monochrome print mode. In the color print mode, the intermediate transfer belt 14 is sandwiched at four nip areas formed by the four photo conductors of yellow (Y), magenta (M), cyan (C) and black (K) and the four transfer rollers. So that compared with the monochrome print mode provided with one nip area formed by the black (K) photo conductor 16k and the transfer roller 20K, the color print mode is less affected by the effect when the recording medium pushes into or escapes from the secondary transfer position. For the reason, the winding amount of the intermediate transfer belt 14 around the photo conductor 16K may be increased only in the monochrome print mode. In such the case, to provide a mechanism that the idle roller 45 moves interlocking with switching to the monochrome print mode is effective.

The invention is not limited to the foregoing embodiments but various changes and modifications of its components may be made without departing from the scope of the present invention. Also, the components disclosed in the embodiments may be assembled in any combination for embodying the present invention. For example, some of the components may be omitted from all the components disclosed in the embodiment. Further, components in different embodiments may be appropriately combined.

What is claimed is:

1. An image transfer device, comprising:
an endless transfer belt which is belted movably around a pair of separate supporting members to form a belt loop;
a transfer member facing an image carrier via the transfer belt, to transfer a developed image formed on the image carrier onto the transfer belt; and
a belt pressing member configured to act the transfer belt to increase an area of the transfer belt contacting the image carrier.

2. The device of claim 1, the belt pressing member being arranged to expand the belt loop outside in a state that the belt pressing member contacts the image carrier via the transfer belt.

3. The device of claim 1, the belt pressing member being an idle roller which is driven and rotating by a movement of the transfer belt.

4. The device of claim 1, further comprising:
a secondary transfer member which contacts one of a pair of the supporting members at a secondary transfer position, the secondary transfer member further transferring the developed image transferred on the transfer belt onto a recording medium at the secondary transfer position.

5. The device of claim 4, a plurality of the image carriers being located along the transfer belt, and the belt pressing member being located at the image carrier positioned closest to the secondary transfer position.

6. The device of claim 1, further comprising:
a switching portion to switch to a state that the image carrier is separated from the transfer belt, the belt pressing member and the transfer belt being separated from the image carrier when the switching portion switches to the state that the image carrier is separated from the transfer belt.

7. The device of claim 1, the transfer members facing the image carrier for a color use on a surface of which a color image is formed and the image carrier for a monochrome use on a surface of which a monochrome image is formed via the transfer belt, to transfer the images formed on the image carriers onto the transfer belt,
further comprising a switching portion to switch between a color print mode in which both the image carrier for the color use and the image carrier for the monochrome use contact the transfer belt and a monochrome print mode in which only the image carrier for the monochrome use contacts the transfer belt, and
the belt pressing member being located to face the image carrier for the monochrome use via the transfer belt and to increase an area where the transfer belt contacts the image carrier for the monochrome use when the switching member switches to the monochrome print mode.

8. An image forming apparatus, comprising:
a supply potion to supply a recording medium;
an image forming portion to form a document image as a developed image on an image carrier; and
a transfer device to transfer the developed image formed on the image carrier onto an endless transfer belt;
the transfer device including:
a pair of supporting members arranged separately around which the endless transfer belt is belted movably to form a belt loop;
a transfer member facing the image carrier via the transfer belt to transfer the developed image formed on the image carrier onto the transfer belt;
a secondary transfer member located at a secondary transfer position to further transfer the developed image transferred on the transfer belt onto the recording medium supplied from the supply portion; and
a belt pressing member configured to act the transfer belt to increase an area of the transfer belt contacting the image carrier.

9. The apparatus of claim 8, the belt pressing member being arranged to expand the belt loop outside in a state that the belt pressing member contacts the image carrier via the transfer belt.

10. The apparatus of claim 8, the belt pressing member being an idle roller which is driven and rotating by a movement of the transfer belt.

11. The apparatus of claim 8, a plurality of the image carriers being located along the transfer belt, and the belt pressing member being located at the image carrier positioned closest to the secondary transfer position.

12. The apparatus of claim 8, further comprising:
a switching portion to switch to a state that the image carrier is separated from the transfer belt, the belt pressing member and the transfer belt being separated from the image carrier when the switching portion switches to the state that the image carrier is separated from the transfer belt.

13. The apparatus of claim 8, the image forming portion forming the document image as the developed image both on the image carrier for a color use and the image carrier for a monochrome use or only on the image carrier for the monochrome use; the transfer members facing the image carrier for a color use on a surface of which a color image is formed and the image carrier for a monochrome use on a surface of which a monochrome image is formed via the transfer belt, to transfer the images formed on the image carriers onto the transfer belt,
further comprising a switching portion to switch between a color print mode in which both the image carrier for the color use and the image carrier for the monochrome use contact the transfer belt and a monochrome print mode in which only the image carrier for the monochrome use contacts the transfer belt, and
the belt pressing member being located to face the image carrier for the monochrome use via the transfer belt and to increase an area where the transfer belt contacts the image carrier for the monochrome use when the switching member switches to the monochrome print mode.

14. An image transferring method, comprising:
contacting an endless transfer belt which is belted movably around a pair of separate supporting members to form a belt loop, with an image carrier for a color use and an image carrier for a monochrome use;
transferring a developed image formed on the image carrier for the color use and the image carrier for the monochrome use on the transfer belt;
separating the transfer belt from the image carrier for the color use, and switching the transfer belt to contact only the image carrier for the monochrome use;
acting a pressing member to the transfer belt when switching, to increase an area of the transfer belt contacting the image carrier for the monochrome use; and
transferring the developed image formed on the image carrier for the monochrome use onto the transfer belt.

15. The method of claim 14, the pressing member expanding the belt loop outside in a state that the pressing member contacts the image carrier via the transfer belt.

16. The method of claim 14, the belt pressing member being an idle roller which is driven and rotates by a movement of the transfer belt.

17. The method of claim 14, further comprising:
transferring further the developed image transferred on the transfer belt from the image carrier onto a recording medium at a secondary transfer position.

18. The method of claim 17, a plurality of the image carriers being located along the transfer belt, and the belt pressing member being located at the image carrier positioned closest to the secondary transfer position.

19. The method of claim 14, further comprising:
separating the transfer belt from the image carrier for the color use and the image carrier for the monochrome use; and
separating the pressing member and the transfer belt from the image carrier for the monochrome use.
